(19) United States
(12) Patent Application Publication
(10) Pub. No.: US 2002/0019762 A1
(43) Pub. Date: Feb. 14, 2002

(54) Electric power demand prediction method and system therefor

(76) Inventors: Yasushi Tomita, Mito (JP); Yasushi Harada, Hitachi (JP); Harumi Uchigasaki, Hitachinaka (JP); Chihiro Fukui, Hitachinaka (JP); Yutaka Kokai, Hitachinaka (JP); Hiroshi Inoue, Hitachi (JP); Nobuhisa Kobayashi, Hitachinaka (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/810,573

(22) Filed: Mar. 19, 2001

(30) Foreign Application Priority Data
Jul. 21, 2000 (JP) 2000-220031

(51) Int. Cl. G06F 17/60

(52) U.S. Cl. 705/10

(57) ABSTRACT

An electric power demand prediction service method and a system therefor may derive an estimated value and/or predicted value of electric power demand of an arbitrary customer group and provide the derived information to electric power suppliers. The electric power demand prediction service method in supplying an electric power from an electric power supplier to an energy consumer includes steps of connecting a power supplier supplying an electric power to the energy consumer through a communication circuit, receiving an electric power demand and supply record data measured and collected by the electric power supplier, performing prediction calculation of demand power to be supplied from the electric power supplier on the basis of the received record data, delivering the power demand prediction data to the electric power supplier, calculating a charge for the service producing the prediction data to the electric power supplier, and delivering a result of charge calculation process to the electric power supplier.

### BACKGROUND OF THE INVENTION

The present invention relates to an electric power demand prediction method and a system therefor for providing a prediction of an electric power demand under a contract with an electric power supplier or an electric power company.

### DESCRIPTION OF THE RELATED ART

Conventionally, prediction of electric power demand is performs by predicting a total demand per an individual electric power company for controlling power supply by determining power plants bearing a basic and constant power load and power plants variable of outputs depending upon variation of power load. The electric power demand prediction has been thus performed by each individual electric power company independently of the other. Furthermore, the prediction is per facility held by the electric power company. However, in the environment where energy consumers may freely select electric power suppliers and/or electric power companies for receiving service, the conventional manner of prediction and electric power supply control cannot be always adapted to electric power condition.

Conventionally, there is no business entity performing electric power supply services. Therefore, it has merely be performed by each electric power company to predict electric power demand in each territory for performing electric power supply control. For instance, prediction is performed electric power demand for next day or week or a predetermined period on the basis of a weather report, day of the week or past record value in the same season in the past, for reflecting to the electric power supply control. The prior art relating to the electric power demand prediction has been disclosed in Japanese Patent Application Laid-Open No. Heisei 11-346438. Disclosed in the above-identified publication is a method for automatically predicting a demand of electric power in a central load dispatching and liaison office. The publication also discusses about a prediction method which is generally applicable for various prediction model, such as feedback type, neural network and so forth.

The prior art disclosed in the above-identified publication is not electric power demand prediction and control adapting to liberalization of power supply. This is not satisfactory in the liberalized environment of power supply. Particularly, under the liberalized environment, electric power supply satisfactory both for the energy consumers and electric power supplier or electric power company cannot be realized unless more precise and more careful prediction and control are performed. Especially, when a business entity of electric power supply service performs power supply under contract with the energy consumers, proper electric power demand prediction becomes an important task.

On the other hand, it becomes necessary to obtain estimated value or predicted value of electric power demand per customer group grouped per facility of electric power system on the basis of contracts with electric power suppliers, namely, so-called retail business of electric power organized according to liberalization of power supply. Furthermore, if estimation and prediction of demand is performed per retail seller of electric power, only information of energy consumers who engage contract with the retail seller to restrict in improvement of precision of an estimated value or predicted value.

### SUMMARY OF THE INVENTION

It is therefore an object of the present invention to provide an electric power demand prediction service method and a system therefor, which may derive an estimated value and/or predicted value of electric power demand of an arbitrary customer group and provide the derived information to electric power suppliers (which generally refers to those supplying electric power, including retail sellers of electric power, electric power companies and so forth).

According to the first aspect of the present invention, an electric power demand prediction service method in supplying an electric power from an electric power supplier to an energy consumer, comprises the steps of:

connecting a power supplier supplying an electric power to the energy consumer through a communication circuit;

receiving an electric power demand and supply record data measured and collected by the electric power supplier;

performing prediction calculation of demand power to be supplied from the electric power supplier on the basis of the received record data;

delivering the power demand prediction data to the electric power supplier;

calculating a charge for the service producing the prediction data to the electric power supplier; and

delivering a result of charge calculation process to the electric power supplier.

According to another aspect of the present invention, an electric power demand prediction service system in supplying an electric power from an electric power supplier to an energy consumer, comprises:

a demand prediction service center including:

electric power demand and supply record data receiving portion connected with a power supplier supplying an electric power to the energy consumer through a communication circuit, and receiving an electric power demand and supply record data measured and collected by the electric power supplier;

predicting portion performing prediction calculation of demand power to be supplied from the electric power supplier on the basis of the received record data;

delivering portion delivering the power demand prediction data to the electric power supplier;

charge calculation processing portion calculating a charge for the service producing the prediction data to the electric power supplier; and

delivering portion delivering a result of charge calculation process to the electric power supplier, for providing the prediction data of the demanded power to the electric power supplier.

In the preferred construction, the demand prediction service center may perform prediction of the demanded power using demanded power prediction data held by the electric power supplier or database of external organization in addition to power demand and supply record data. The demand prediction service center may cumulatively store demanded prediction data for the electric power supplier in a customer data file and make reference to the customer data file upon demand prediction. The demand prediction service center may be the predicting portion which performs prediction of demanded power on the basis of reception signal of a load survey data or distribution line measurement data of the electric power supplier or a result of cluster analysis of load curve record value. The charge processing portion to the electric power supplier in the demand prediction service center may be a charge processing portion determining a charge to a customer on the basis of at least one of precision of prediction, size of geometric area, length of prediction period, time interval of prediction per se, and size of electric power variation amount in the load curve in a prediction time zone.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a block diagram showing a overall construction of a prediction service system according to the present invention, which includes a demand prediction service center;

FIG. 2 is a block diagram of a construction of a demand prediction service center according to the present invention;

FIG. 3 is an illustration showing one example of a structure of database on the side of customer;

FIG. 4 is an illustration for explaining a predicted data obtained per king of contract;

FIG. 5 is an illustration showing a general flow of demand prediction process in the prediction service center;

FIG. 6 is a general explanatory illustration for explaining a demand predicting method;

FIG. 7 shows one example of the result of demand prediction;

FIG. 8 is a general explanatory illustration of a data file of customer (electric power supplying business entity) held by the prediction service center;

FIG. 9 is a flowchart showing one example of accounting process; and

FIG. 10 is an illustration showing a accounting objective prediction condition for a predetermined period per electric power supplying business entity.

### DESCRIPTION OF THE PREFERRED EMBODIMENTS

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure are not shown in detail in order to avoid unnecessary obscurity of the present invention.

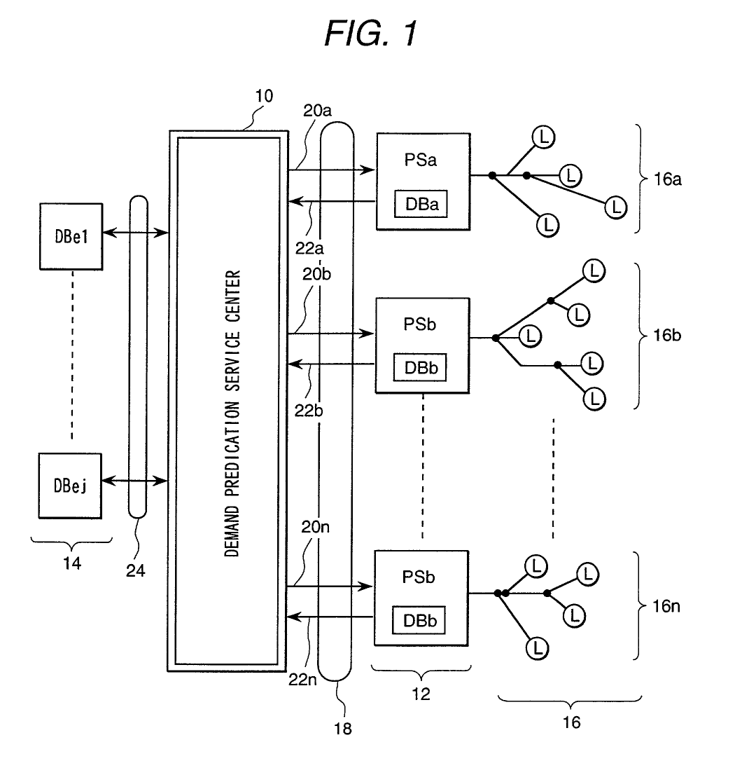

FIG. 1 is a block diagram showing the overall construction of a demand prediction service system according to the present invention. The reference numeral 10 denotes an electric power demand prediction service center (or may also be referred to as an electric power demand prediction business entity). A construction of the electric power demand prediction service center will be discussed later. The electric power supply business entities include those identified by PSa to PSn. DBa to DBn identify databases respectively held by the electric power supply business entities PSa to PSn, in which data necessary for demand prediction is stored. Thus, among data stored in the database, necessary data for predicting electric power demand is provided to the demand prediction service center 10. Among data stored in the database, it includes prediction data predicted by the electric power supply business entity independently. Then, such prediction data is configured to be used by the service center as a basic data.

PSn (n=a to n) identifies the electric power supply business entity including the electric power companies, retail sellers of electric power, such as electric power service business entities, having contract with the electric power company or other electric power supply business entity. Irrespective of scale of the business entities, the electric power supply business entity controlling supply power depending upon predicted demand of the electric power, is a target of he service. The reference numeral 16 denotes a energy consumer (L). To the electric power supply business entry PSa, an energy consumer group 16a is connected for receiving service of electric power in accordance with contracts. The reference numeral 16b denotes an energy consumer group receiving service of electric power from the electric power supply business entity PSb. Similarly, the reference numeral 16n denotes an energy consumer group receiving service of electric power from the electric power supply business entity PSn. The reference numeral 18 denotes a communication circuit, such as internet, to be used for sending request of electric power demand prediction, providing data, providing the result of prediction, delivery of bill for charges, other demands and so forth between the electric power supplier and the electric power demand prediction service center 10. For example, in case of PSa, 20a represents transmission channel for delivery prediction result data to PSa and 20b represents transmission channel for sending data and request for prediction of demand and other request from PSa to the service center 10. Similarly, signal lines 20b to 20n and 22b to 22n are channels to be used for communication between respectively corresponding electric power suppliers and the service center 10.

The reference numeral 14 denotes database of an external organization to be accessed when data of external organization is used as an auxiliary data. In this case, databases of the external organizations are identified by DBe1 to DBej. The database of external organization may include database of public agency and so forth. Data to be obtained from the database of the external organization, may be weather, or electric power demand record of local area or whole country in the past and so forth. The reference numeral 24 denotes a communication circuit, such as internet, similar to the communication circuit 18 and to be used for obtaining data from external organization, as required. It should be appreciated that use of the database of the external organization is not essential for certain prediction service center of certain function.

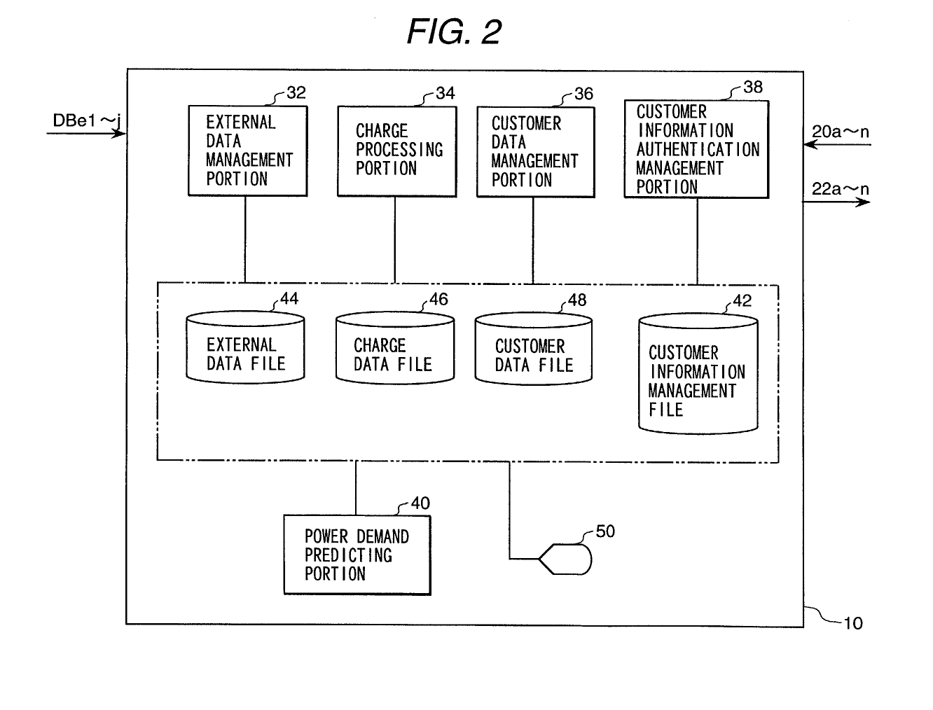

FIG. 2 shows a construction of the demand prediction service center 10 which is constructed with microcomputer and so forth. The reference 38 is a customer information authentication and management portion which receives signals 22a to 22n from the customer (in this case, electric power supplier, performs authentication by checking whether the customer in access is authorized customer under contract, contract condition and so forth on the basis of password or the like input by the customer, and performs management process using a customer information management file 42 with updating customer data for preparation to the next request for prediction.

The reference numeral 34 denotes an accounting portion for performing charge calculation for prediction service. The accounting portion performs charge calculation using data in a charge data file 46 depending upon requesting condition of prediction within a given period. The reference numeral 32 denotes an external data managing portion which is active when data provided by the customer is not sufficient for satisfying a condition for performing prediction requested by the customer and when judgment is made that data from the external organization may satisfy the requested precision of the demand prediction. The external data managing portion 32 will then access the external database, such as data base of public agency (or private organization) to obtain necessary information. The external data managing portion 32 also manages obtaining of data and stores the obtained data in an external data file for re-used in the future.

Accordingly, when corresponding data is not stored in the file 44, data is newly obtained from the external organization. For example, in FIG. 2, if data is lacking in the data file 48 from the customer, the accumulated data file 44 of the external data is assessed for newly obtaining necessary data. If data is still lacking after accessing the accumulated data file 44, the database of the external organization is accessed for newly obtaining necessary data. In such case, use of the accumulated data file and access to the database of external organization and so forth are taken into account in accounting process. In general, use of the accumulated data file and access to the database of external organization and so forth become necessary upon lacking of relatively new data or when data at different viewpoint is desired for predicting operation. The reference numeral 40 denotes a predicting operation processing portion performing actual predicting operation using data obtained as set forth above. The predicting operation processing portion 40 includes various prediction libraries, such as a numerical value processing library, a clustering analysis library, a domestic power consumption model analysis library and so forth, which may significantly influence for quality of prediction data of the demand prediction service center 10. The reference numeral 50 denotes a display device provided in the service center 10 for displaying result of prediction or process of predicting operation. The display device 50 is used for checking information before transmitting prediction data to the electric power supplier and for other purpose.

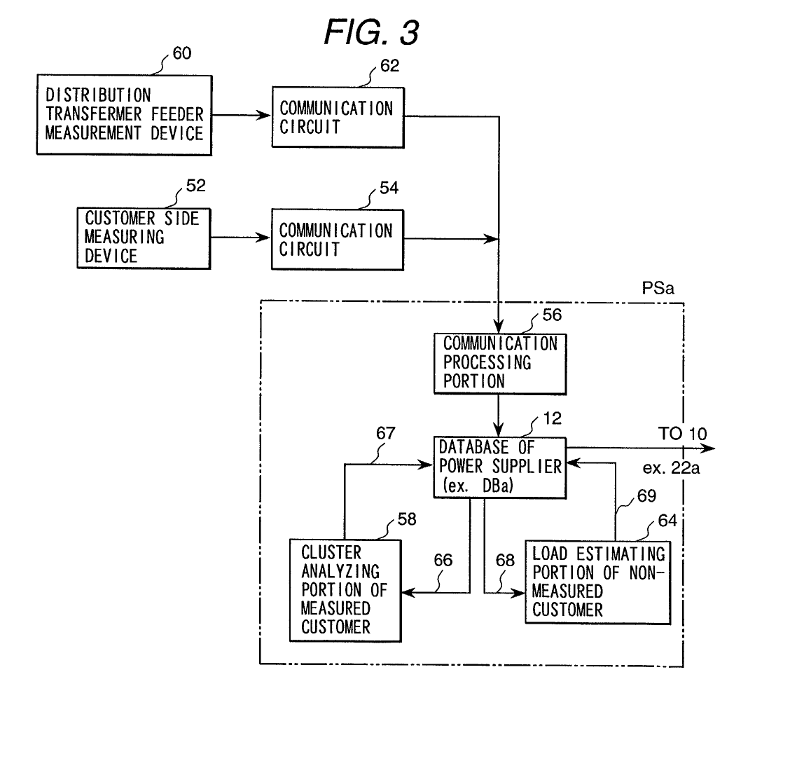

FIG. 3 is an explanatory illustration showing one example of a construction on the side of the electric power supplier. FIG. 3 shows the case of PSa. It should be noted that the construction in each individual electric power supplier is not necessarily the same as that of PSa as illustrated. Each electric power supplier often have own database. As shown in FIG. 3, an electric power consuming amount measuring value 52 of the end customer (energy consumer) is transmitted to the database of the electric power supplier through a communication circuit 54. On the other hand, the reference numeral 60 denotes a distribution transformer feeder transmission measuring device connected to the power supplier side through a communication circuit 62 for inputting a measured value. On the power supplier side, the measured value is cumulatively stored in the database (e.g. DBa) of the power supplier through communication process (56).

The reference numeral 58 denotes a customer demand cluster analyzing portion, which takes an input signal, such as load curve record value measured by the customer or the general information of the customer to perform analysis. A signal 67 indicative of result of analysis is input and stored to the database 12 (DBa), Thus, the data base on the side of the power supplier not only holds the measured data per se as data base but also stores the result of analysis on the side of the customer. On the other hand, for the customer having no measuring device, a result estimated from general information is stored in the database. As set forth above, DBa, for example, is a database unique for the customer. Predicting operation is performed in the prediction service center with effectively using data stored as set forth above for further precise prediction. Data necessary for prediction from data of the DBa is fed to the demand prediction service center 10 shown in FIG. 1 to receive the predicted result to perform power generation control.

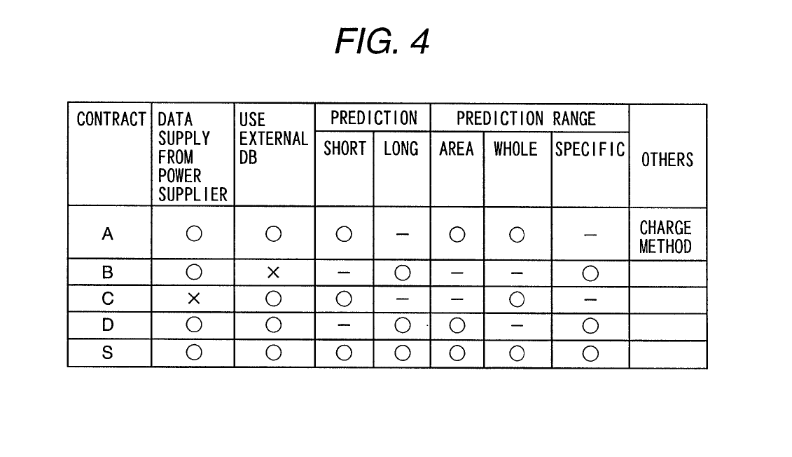

FIG. 4 shows an example of demand prediction contract between the demand prediction service center 10 and the power supplier. In the demand prediction service center 10, demand prediction service is performed depending upon content of contract with the power supplier. Here, there is shown an example of the case where kinds of contracts are A to S. For example, a contract A includes data provided from the power supply business entity, which represents presence of analysis data of the power supplier own including the measured data. A contract C is the case where no data can be provided and data of the external organization has to be relied. In FIG. 4, the item next to the contract item is the item indicative whether the external database has to be used for satisfying demand of the demand prediction or not. In the contract A, the database of the external organization is used under contract. Namely, the second item indicates whether the database of the external organization is to be used when the data provided by the electric power supplier or the electric power supply business entity is lacking for satisfying the prediction demand. The contract B does not use the data of the external organization and performs prediction based on the data provided from the electric power supplier, the data held by the prediction service center, know how of prediction, tool of prediction and so forth.

The items next to the second item represent prediction period. Namely, the item in question is whether the demand period is only long term or short term. In the shown example, the contract A is only short period prediction. On the other hand, the contract B represents that the requested prediction is only long term prediction. The items next to the prediction period items concern predicting region. This item indicates whether the prediction has to be made for a designated area, all area or for particular energy consumer, among energy consumers being supplied the electric power from the electric power supplier. Under the contract A, in addition to a prediction for the particular area, demand prediction information for the overall area has to be supplied to the electric power supplier. On the other hand, the contract S has a content requiring prediction for all items, namely for all of the particularly designated area, the overall area and particular energy consumer. These are only basic contract, and the customer (electric power supplier) may receive prediction service beyond the content of contract, In such case, charge will be considered in accounting.

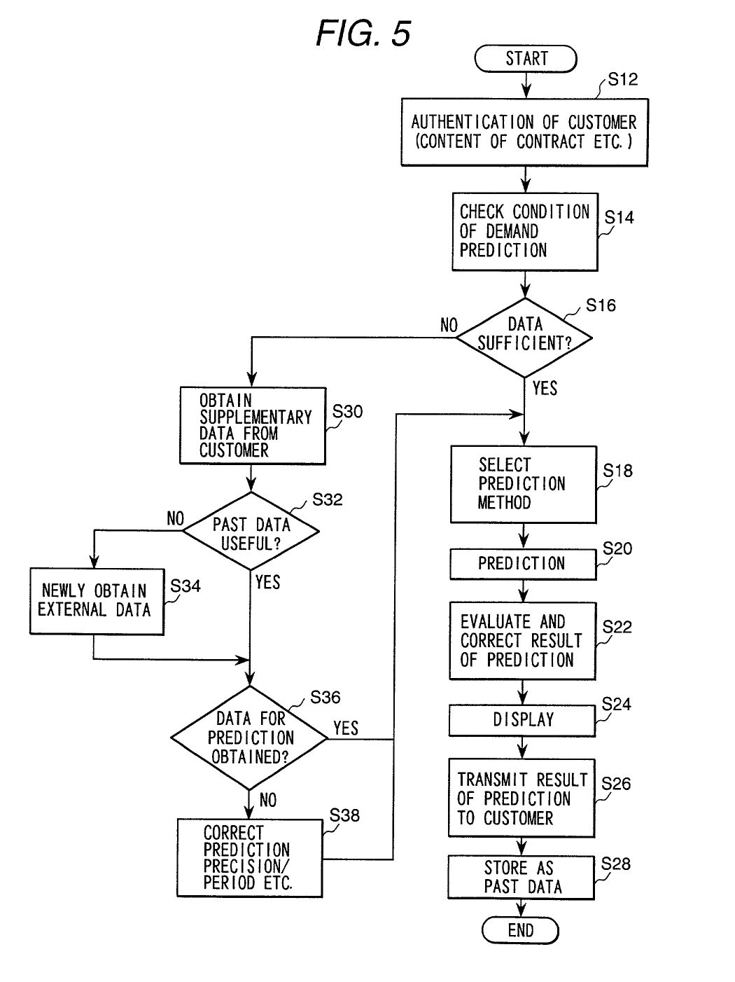

FIG. 5 is a process flowchart in the service center 10 in the case where predicting operation is performing according to the request for demand of prediction. At step S12 (e.g. 20a), authentication is performed whether the power supplier requesting prediction is has authority under contract or not by checking pass word or the like. Also, at step S12, the content of contract is also checked for the electric power supplier for which authentication is successful. Next, at step S14, a condition of demand prediction is checked. For example, check is performed for the period of prediction under contract, required precision, necessary data for required precision and so forth as the condition for prediction. Then, at step S16, check is performed whether data is sufficient for making prediction satisfying the demand of the power supplier. If the conditions set forth above are satisfied, predicting operation is performed with selecting the prediction method among a plurality of prediction methods or selection of the prediction method is performed at step S18. Namely, in selection at step S18, whether the required precision of prediction can be made by only correction of the existing prediction pattern, by complicate converging calculation or so forth adapting to demand of the customer. Then, at step 20, particular predicting operation is performed.

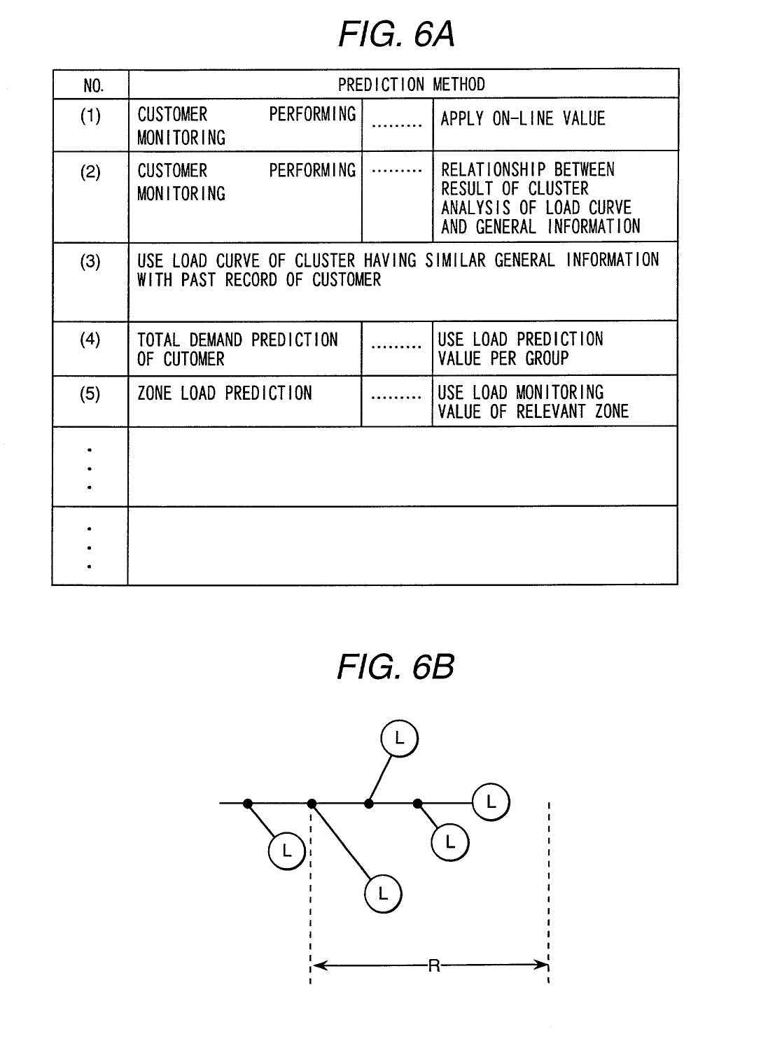

FIG. 6A shows an example of the prediction method. For example, (1) when the customer (here, the power supplier is referred to) monitors power supply amount, prediction is performed using on-line data resulting from monitoring, (2) when the customer monitors power supply amount, prediction is performed using the result of clustering analysis made by the customer and the general information. (3) is the case where prediction is performed using past record. (4) is a the case where prediction of total demand is performed on the basis of load prediction value per group. (5) is the case of prediction per particular period which is the case to perform prediction with respect to the period R as shown in FIG. 6. The predicting method will be selected adapting to respective cases.

At step S22, evaluation and correction is effected for the result of predicting operation. For example, in evaluation and correction, check is performed whether the predicted pattern is not significantly differentiated from the past predicted pattern or whether the predicted pattern is quite similar to the past predicted pattern. Evaluation and correction may be done with displaying the predicted pattern on a display device at display step S24. At step S26, the result of prediction is transmitted to the customer (electric power supplier). At step S28, the result of prediction is held as database for use in the next predicting operation.

On the other hand, if judgment is made that data is lacking for the predicting operation as checked at step S16, the lacking data is obtained from the customer (power supplier) at step S30. On the other hand, at step S32, judgment is made whether data taken from the external organization can be used for prediction or not. If the data obtained from the external organization can be used, check is performed whether all data necessary for predicting operation are obtained or not at step S36. If judgment is made that all necessary data is corrected, predicting operation is performed at step S18 and subsequent steps. Correction for precision or so forth to be performed at step S38 is effected when the demanded precision of prediction data cannot be obtained by data obtained from the external database. In such case, predicting operation is executed with correcting the precision to the level to be achieved by the given data or correcting the prediction period. At step S32, when judgment is made that the already obtained external data is not useful, data is again obtained from the external database. Of course, such effort should be taken into account upon accounting process.

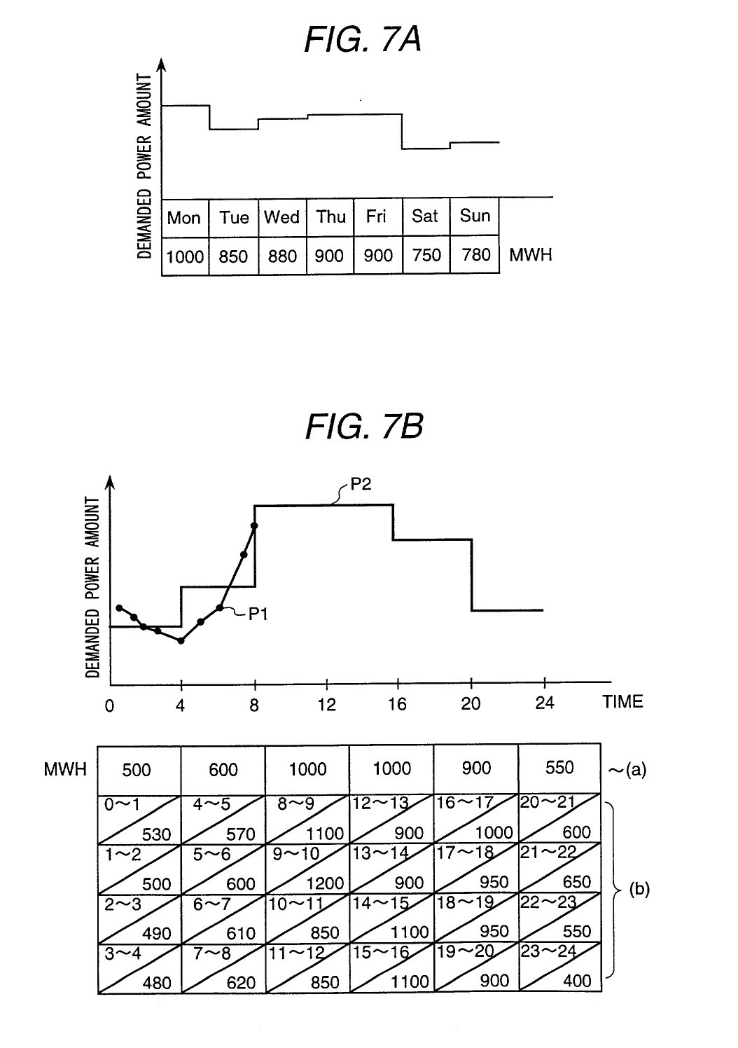

FIGS. 7A and 7B show particular example of the result of predicting operation. FIG. 7A shows the result of prediction per week, and shows an average demanded power amount predicted per week and per days of the week. On the other hand, FIG. 7(B) shows a result of prediction (P1) effected per hour of day (twenty-four hours) and also shows an average demand power amount (P2) at every four hours. (a) in FIG. 7(B) shows the average power amount at every four hours and (b) shows the predicted value of the average demand power amount at every one hour.

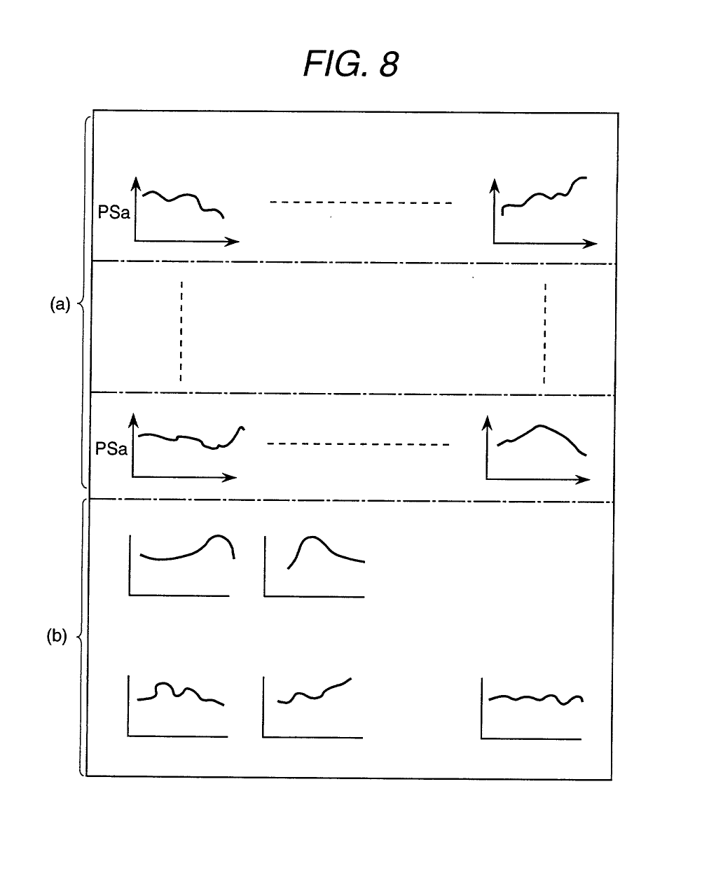

FIG. 8 shows an example of a graph of the customer data file data. The lateral axis represents a time axis in broad meaning and including hour, week and so forth. In FIG. 8, (a) is the past power demand pattern per the electric power supplier and is a demand prediction pattern per week as shown in FIG. 7A or demand prediction for a day (twenty-four hours) or other various load demand model patterns. Such load demand model pattern is stored to be made reference to upon subsequent demand prediction for improving precision in demand prediction, shortening of operation period of the demand prediction. (b) of FIG. 8 shows model as common demand pattern in the power suppliers PSa to PSn to be used for any of power suppliers. By making these data reference to, precise prediction can be done quickly. Models for the case where it is desired to perform pattern correction at different viewpoint or when power demand pattern of the power supplier is to be predicted, the models of the patterns are stored for use.

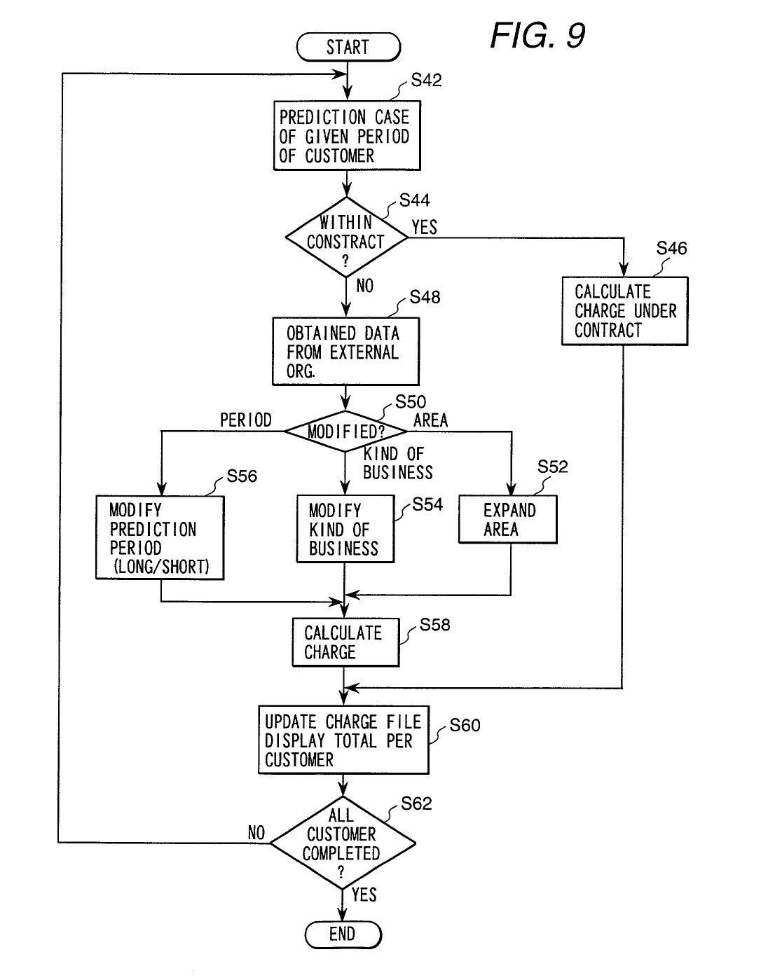

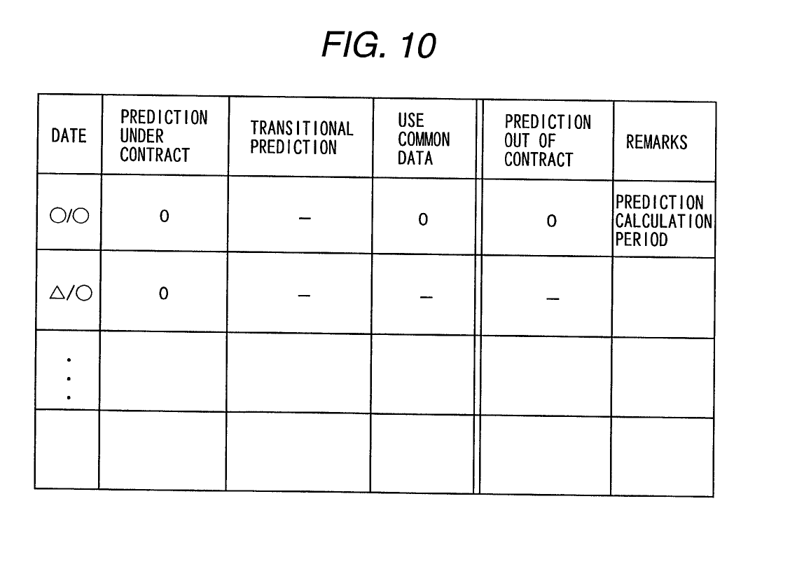

FIG. 9 is a flowchart for explaining charging operation. At step S42, the case of the predicting operation in the predetermined period of the customer is picked up. For example, as shown in FIG. 10, predicted information providing condition for a predetermined period per the power supplier is derived. Then, on the basis of such record, accounting process for the predetermined period is performed.

At step S44, judgment is made whether the picked-up case of predicting operation of the customer falls within the range of contract or not. If the picked up case of prediction operation falls within the range of contract, charge calculation is performed according to the contract at step S46. However, in some of the customer, all of the cases of prediction operation may not fall within the range of contract. If some cases of prediction operation falls out of the contract, the total charge to be billed to the customer may be derived with taking the extra service into account at step S60, at which the total charge is displayed per customer and charge file is updated. On the other hand, some customer may have the contract for a fixed amount charge to be billed at step S46.

If judgment is made that some prediction operation does not fall within the contract as checked at step S44, check is performed whether data is obtained from the external database out of contract at step S48. At step S50, check is made what modification has been made with respect to the content of contract. For example, when the area to perform prediction operation is modified with respect to the initially set area, check is made at step S52. When the area is modified to expanding or contracting the area as checked at step S52, such modification of the area is reflected upon charge calculation at step S58. On the other hand, at step S54, it is also checked whether kind of business to make prediction operation is changed or not. If the kind of business is changed, the fact is reflected upon charge calculation at step S58. Change of kind of business means that power demand prediction of manufacturing industry is initially requested and subsequently demand prediction including complex housing is requested, or subsequently request is changed to prediction of the complex housing, for example. At step S56, check is performed whether prediction period has been changed or not. For example, modification from short period to long period or change of season among short period and any change for frequency of initial prediction may be checked at step S56. Then, any change of the prediction frequency is reflected to charge calculation.

As set forth, at step S60, for some customer, part of service may fall out of the contract. In such case, total charge to be billed is calculated with including the charge for the service within the contract and the extra charge for the service out of contract. At step check is performed whether charge calculation is completed for all customers.

It is possible that some of the customers form a group to be a single customer. Also, the customer can be a power supply service business entity. All of such customers may be simply deal as customer. If special treatment is required, necessary special treatment will be handled in a content of the contract to reflect such special treatment in calculation of charge. Also, when database of the external organization is used, such charge portion may be pointed out to the customer.

Also, in the charge calculation process, consideration will be made for the case where charge depending upon precision level of prediction, namely higher precision result in higher charge, or where prediction can be made with only modification of the prediction data provided by the power supplier. Also, when the load prediction pattern is similar to that of other power supplier to perform correcting prediction based thereon. With making reference to the prediction pattern of a plurality of power suppliers, prediction data with higher precision may be provided.

As set forth above, with the present invention, since the electric power supplier may preliminarily engage with the demand prediction service center under contract and provide data necessary for prediction, an appropriate prediction data can be obtained for efficiently control demand and supply. On the other hand, since the demand prediction service center has a charge system to the electric power supplier through charge calculation process depending upon provided prediction data, substantial effect can be achieved in billing.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. An electric power demand prediction service method in supplying an electric power from an electric power supplier to an energy consumer, comprising the steps of:
connecting a power supplier supplying an electric power to the energy consumer through a communication circuit;
receiving an electric power demand and supply record data measured and collected by said electric power supplier;
performing prediction calculation of demand power to be supplied from said electric power supplier on the basis of said received record data;
delivering said power demand prediction data to said electric power supplier;
calculating a charge for the service producing said prediction data to said electric power supplier; and
delivering a result of charge calculation process to said electric power supplier.

2. An electric power demand prediction service method as set forth in claim 1, wherein the prediction of the demanded power is performed using demanded power prediction data held by said electric power supplier or database of external organization in addition to power demand and supply record data.

3. An electric power demand prediction service system in supplying an electric power from an electric power supplier to an energy consumer, comprising:
a demand prediction service center including:
electric power demand and supply record data receiving portion connected with a power supplier supplying an electric power to the energy consumer through a communication circuit, and receiving an electric power demand and supply record data measured and collected by said electric power supplier;
predicting portion performing prediction calculation of demand power to be supplied from said electric power supplier on the basis of said received record data;
delivering portion delivering said power demand prediction data to said electric power supplier;
charge calculation processing portion calculating a charge for the service producing said prediction data to said electric power supplier; and
delivering portion delivering a result of charge calculation process to said electric power supplier, for providing the prediction data of the demanded power to said electric power supplier.

4. An electric power demand prediction service system as set forth in claim 3, wherein said demand prediction service center performs prediction of the demanded power using demanded power prediction data held by said electric power supplier or database of external organization in addition to power demand and supply record data.

5. An electric power demand prediction service system as set forth in claim 3, wherein said demand prediction service center cumulatively store demanded prediction data for the electric power supplier in a customer data file and make reference to said customer data file upon demand prediction.

6. An electric power demand prediction service system as set forth in claim 3, wherein said demand prediction service center is said predicting portion which performs prediction of demanded power on the basis of reception signal of a load survey data or distribution line measurement data of the electric power supplier or a result of cluster analysis of load curve record value.

7. An electric power demand prediction service system as set forth in claim 3, wherein the charge processing portion to the electric power supplier in the demand prediction service center is a charge processing portion determining a charge to a customer on the basis of at least one of precision of prediction, size of geometric area, length of prediction period, time interval of prediction per se, and size of electric power variation amount in the load curve in a prediction time zone.
